(19) United States
(12) Patent Application Publication
(10) Pub. No.: US 2010/0148685 A1
(43) Pub. Date: Jun. 17, 2010

(54) INTEGRATED DIMMABLE COMPACT FLUORESCENCE LAMP AND CIRCUIT USED THEREIN

(75) Inventors: Chao Hong Du, Guangdong (CN); Xiangfen He, Guangdong (CN)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/632,904

(22) Filed: Dec. 8, 2009

(30) Foreign Application Priority Data
Dec. 8, 2008 (CN) 200810185714.9

(51) Int. Cl. H05B 41/36

(52) U.S. Cl. 315/246

(57) ABSTRACT

The present invention discloses an integrated dimmable compact fluorescence lamp and a circuit used therein. The circuit includes: a dimming module configured to adjust the brightness of the compact fluorescence lamp by controlling the frequency of a voltage to be output to a control module, wherein the dimming module includes the following: a control part configured to receive a first electrical signal from an input module and an electrical feedback signal from a lamp tube of the compact fluorescence lamp, generate an electrical reference signal which represents a part of the first electrical signal or the whole electrical signal, adjust the electrical reference signal as reaction to an external operation and output the electrical reference signal and the electrical feedback signal to a frequency adjustment part to control the frequency of a voltage output from the frequency adjustment part; and the frequency adjustment part configured to receive the first electrical signal from the input module, generate the frequency of the voltage to be output to the control module and adjust the frequency of the voltage as reaction to the electrical reference signal and the electrical feedback signal.

### CROSS-REFERENCE TO RELATED APPLICATION

This application claims priority to Chinese Patent Application No. 200810185714.9, which was filed Dec. 8, 2008, and is incorporated herein by reference in its entirety.

### FIELD OF THE INVENTION

The present invention relates generally to a dimmable compact fluorescence lamp and relates particularly to an integrated dimmable compact fluorescence lamp (CFL) and a circuit used therein.

### BACKGROUND

A fluorescence lamp is a low voltage gas discharge lamp and also is a load with negative resistance. Accordingly, the control technology of the fluorescence lamp is more complex than the one of a filament lamp. A traditional compact fluorescence lamp, also referred to as energy-saving lamp, is dimmed by a wall dimmer. The wall dimmer generally is mounted on a position for a switch of the compact fluorescence lamp, and is integrated with a switching function for the compact fluorescence lamp. Generally, different kinds of compact fluorescence lamps each work with a wall dimmer, which is adapted to its kind. For example, the compact fluorescence lamps with different working voltages or working powers work with different wall dimmers. Furthermore, different wall dimmers may lead to different dimming effects at the same compact fluorescence lamp, while the dimming of the same wall dimmer may also lead to different dimming effects at different compact fluorescence lamps.

FIG. 1 shows a schematic circuit diagram of a wall dimmer in the state of the art. In the circuit diagram of FIG. 1, a load 1100 is a compact fluorescence lamp. As shown in FIG. 1, a wall dimmer 1200 is connected in parallel to the load 1100 between the input terminals of the alternating current supply (AC) of the load 1100. The wall dimmer may control the flow angle of a bi-directional silicon rectifier (SCR) by adjusting a control resistance W, whereby the voltage applied to the compact fluorescence lamp is adjusted.

FIG. 2 is a wave form diagram that shows the working principle of the wall dimmer in the state of the art, as shown in FIG. 1. As shown in FIG. 2, the working principle of the wall dimmer as shown in FIG. 1 consists in transforming in fact a complete sinusoidal alternating voltage into an incomplete sinusoidal alternating voltage. In this way, the brightness of the compact fluorescence lamp may be adjusted.

A normal compact fluorescence lamp, however, cannot work directly with the dimmer. To work with the dimmer, the circuit of the compact fluorescence lamp must be specifically designed so that the normal compact fluorescence lamp becomes a dimmable compact fluorescence lamp. There are different dimmable compact fluorescence lamps, which may work with a will dimmer in the art, and therefore, they are not described in detail herein.

Because in the state of the art, the dimmable compact fluorescence lamp and the wall dimmer are separated from each other and both of them need a specific circuit for supporting the dimming function, the structure of the circuits is overall complex and the overall production costs are high.

Because the wall dimmer in the state of the art generally further works as a switch of the dimmable compact fluorescence lamp, furthermore the dimming of the wall dimmer generally has a region from the position forming the highest brightness level.

### SUMMARY

An object of the present invention is providing an integrated dimmable compact fluorescence lamp and a circuit used therein. This integrated dimmable compact fluorescence lamp may be dimmed without an additional dimmer.

According to an embodiment of the present invention, a circuit for a compact fluorescence lamp is provided. The circuit includes: A dimming module, which is configured to adjust the brightness of the compact fluorescence lamp by controlling the frequency of a voltage to be output to a control module, wherein the dimming module includes the following: a control part, which is configured to receive a first electrical signal from an input module and an electrical feedback signal from a lamp tube of the compact fluorescence lamp, generate an electrical reference signal, which represents a part of the first electrical signal or the whole electrical signal, adjust the electrical reference signal as reaction to an external operation and output the electrical reference signal and the electrical feedback signal to a frequency adjustment part, to control the frequency of a voltage output from the frequency adjustment part; and the frequency adjustment part, which is configured to receive the first electrical signal from the input module, generate the frequency of the voltage to be output to the control module and adjust the frequency of the voltage as a reaction to the electrical reference signal and the electrical feedback signal.

According to another embodiment of the present invention, an integrated dimmable compact fluorescence lamp including the above circuit is provided.

In the present invention, the dimming part is integrated in the compact fluorescence lamp and only a single dimming circuit is required. Therefore, the structure of the circuit is overall simple and the production costs are low.

Because of the integrated design it furthermore is not necessary, that the dimming part of the present invention includes a switching function. Thus, dimming of the dimming part may start from an arbitrary brightness level.

### BRIEF DESCRIPTION OF THE DRAWINGS

The above and further objects, features and advantages of the present invention will be better understood by referring to the following description given in connection with the attached figures.

FIG. 1 shows a schematic circuit diagram of a wall dimmer in the state of the art;

FIG. 2 shows a wave form diagram, that shows the working principle of the wall dimmer in the state of the art, as shown in FIG. 1;

FIG. 3 shows a diagram of a circuit for a compact fluorescence lamp according to an embodiment of the present invention;

FIG. 4 shows a diagram of an integrated dimmable compact fluorescence lamp according to an embodiment of the present invention; and

FIG. 5 shows a diagram of an integrated dimmable compact fluorescence lamp according to another embodiment of the present invention.

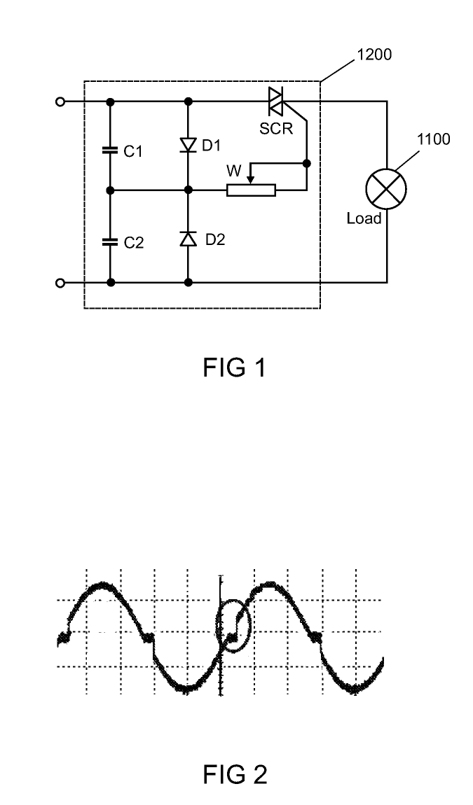

### DETAILED DESCRIPTION

The principle of the embodiments of the present invention consists in integrating a dimming module into a compact fluorescence lamp and adjusting the brightness of the compact fluorescence lamp by controlling the frequency of a voltage output from the dimming module to a control module of the compact fluorescence lamp. The change at the frequency of the voltage output to the control module may cause a change of the working frequency of a lamp tube of the compact fluorescence lamp. Accordingly, the working voltage and the working current of the lamp tube change. In this way, the brightness of the compact fluorescence lamp may be dimmed.

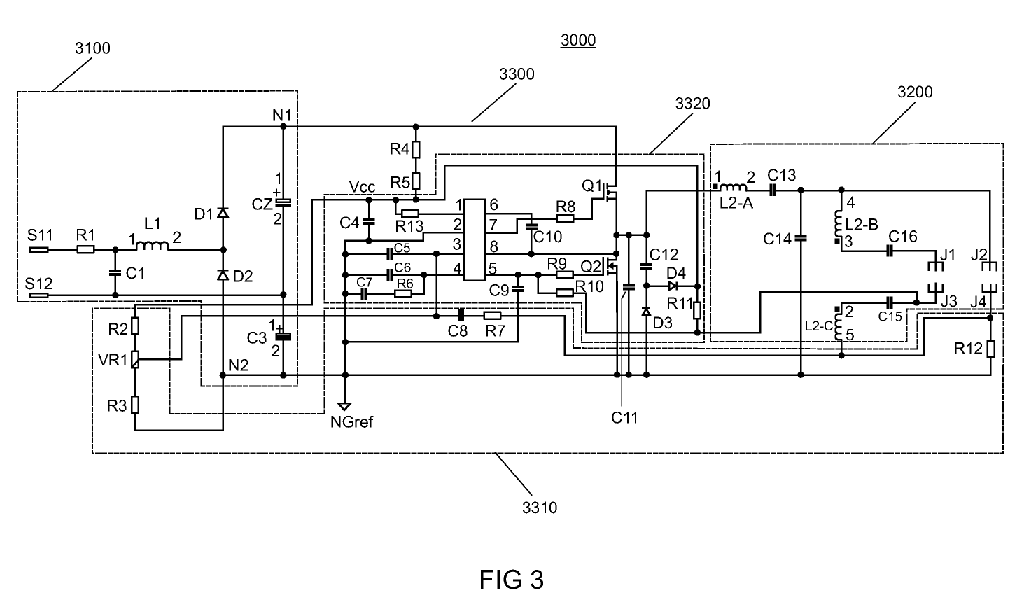

FIG. 3 shows a diagram of a circuit for a compact fluorescence lamp according to an embodiment of the present invention. As shown in FIG. 3, a circuit 3000 includes an input module 3100, a control module 3200 and a dimming module 3300. The input module 3100 is configured to transform a line alternating voltage (AC) into a direct voltage (DC). For example, as shown in FIG. 3, the line alternating voltage is supplied to the terminals S11 and S12 to be applied to the input module 3100, and is then transformed into a direct voltage and output to the output nodes N1 and N2 of the input module 3100. The node N2 is connected to a reference mass node NGref of the circuit 3000. The line alternating voltage is for example an alternating voltage of 120 V/50 Hz or 60 Hz. The person skilled in the art will understand that the line alternating voltage may also be an alternating voltage of 220 V/50 Hz or 60 Hz.

The control module 3200 is configured to supply current to a lamp tube of the compact fluorescence lamp, so that the lamp tube illuminates and so that the lamp tube can work stably. As an example, in FIG. 3 the two pairs of output terminals (J1, J2) and (J3, J4) of the control module 3200 each include a fiber connected between them, i.e. a fiber is connected between the output terminal pair (J1, J2) and another fiber is connected between the output terminal pair (J3, J4).

Here, the input module 3100 and the control module 3200 are circuits in the state of the art, and different ways for implementing of these two modules are known to the person skilled in the art. Therefore, these two modules are not detailed herein.

A dimming module 3300 is connected between the input module 3100 and the control module 3200. In the embodiment of FIG. 3, the dimming module 3300 includes a control part 3310 and a frequency adjustment part 3320.

The control part 3310 receives the direct voltage output from the input module 3100 and an alternating feedback voltage from the lamp tube. The control part 3310 generates a reference direct voltage, which forms a part of the direct voltage output from the input module 3100 or the whole direct voltage. The control part 3310 adjusts the reference direct voltage as reaction to the external operation and outputs the adjusted reference direct voltage and the feedback alternating voltage from the lamp tube to the frequency adjustment part 3320. The frequency adjustment part 3320 receives the direct voltage from the input module 3100 and generates the frequency of a voltage to be output to the control module 3200. The frequency adjustment part 3320 adjusts the frequency of the voltage to be output to the control module 3200 as reaction to the reference direct voltage from the control part 3310 and the feedback alternating voltage.

The frequency adjustment part 3320 may be implemented with an electronic apparatus available on the market like for example an IC chip, which has the function of outputting a voltage with a corresponding frequency as a reaction to a change at the input voltage. The periphery circuit for such an electronic apparatus is also well known to the person skilled in the art.

As an example, in FIG. 3 an IC chip U1 and a periphery circuit of it are used to implement the frequency adjustment part 3320, wherein the IC chip U1 has the function to output a voltage with a corresponding frequency as a reaction to a change at the input voltage. A working voltage input node Vcc of the frequency adjustment part 3320 is connected to a first output node N1 of the input module 3100, and a reference mass input node NGref of the frequency adjustment part 3320, which is also the reference mass input node of the circuit 3000, is connected to a second output node N2 of the input module 3100. In FIG. 3, pin 1 of the chip U1 is connected to the working voltage input node Vcc of the frequency adjustment part 3320 by a resistor R13, and a pin 2 of the chip U1 is connected to the reference mass voltage input node NGref of the frequency adjustment part 3320. The chip U1 receives the reference direct voltage and the alternating voltage from the control part 3310 at its input terminal 3. The chip U1 permanently adjusts the switching frequency at the pins 5 and 7 by checking the voltage at pin 3, whereby the working frequency of the lamp tube is adjusted, the working current of the lamp tube is changed and thus the brightness of the compact fluorescence lamp is adjusted. In an embodiment of the present invention, the switching frequency at the pins 5 and 7 varies between 40 kHz and 80 kHz.

The circuit of the frequency adjustment part 3320, like shown in FIG. 3, is just an example. The person skilled in the art understands a lot of other circuits for implementing the frequency adjustment part 3320 and may conceive them. Therefore, the structure of the frequency adjustment part 3320 will not be further detailed here.

In the embodiment of FIG. 3, the control part 3310 includes a slide resistor VR1. The two ends of VR1 each are connected to the output nodes N1 and N2 of the input module 3100, whereby the direct voltage is received from the input module. The sliding contact P of VR1 is connected to pin 3 of the chip U1 of the frequency adjustment part 3320 and may be displaced by an external operation. With the displacement of the sliding contact P the reference direct voltage to be input from U1 in pin 3 in the region of the received direct voltage.

The control part 3310 further includes a feedback resistor R12. The feedback resistor R12 is connected between the reference mass node NGref of the circuit 3000 and the position of the lamp tube. The end of the feedback resistor R12 connected to the position of the lamp tube is also connected to the input terminal 3 of the frequency adjustment part 3320, i.e. pin 3 of U1. The feedback resistor R12 is a resistor for feeding back the lamp tube current. When the lamp tube current flows through R12, this means that the feedback current flows from the lamp tube through R12. Then, the voltage at R12 may be supplied to the input terminal 3 of the frequency adjustment part 3320. In one embodiment of the present invention the voltage at R12 is an alternating voltage. The alternating voltage supplied from R12 and the reference direct voltage output from VR1 are superimposed with each other at the input terminal 3 of the frequency adjustment part 3320, whereby a sinusoidal voltage to be supplied to pin 3 from U1 is formed.

In the above embodiment, the chip U1 permanently adjusts the switching frequency at the pins 5 and 7 by checking the voltage at pin 3, whereby the working frequency of the lamp tube is adjusted, the working current of the lamp tube is changed and finally the minimum value of the sinusoidal voltage at pin 3 is made zero. When the minimum value of the sinusoidal voltage at pin 3 is zero, an adjustment at the compact fluorescence lamp is completed and the light of the compact fluorescence lamp is stabilized.

In an embodiment of the present invention the control part 3310 may further include a capacitor C8 and a resistor R7.

In the above embodiment, the voltage at pin 3 is influenced by two factors, i.e. the reference direct voltage of VR1 and the alternating voltage of R12. The change at the reference direct voltage of VR1 may finally change the alternating voltage of R12, i.e. may change the working current of the lamp tube. This is a negative feedback procedure, and such a negative feedback procedure may allow that the current of the lamp tube is more stable.

In an embodiment of the present invention, the control part 3310 further includes resistors R2 and R3. The resistor R2 is connected between the slide resistor VR1 and the node N1, and the resistance R3 is connected between the slide resistor VR1 and the node N2. The resistors R2 and R3 are configured to define the voltage adjustment region of the slide resistor VR1, whereby the highest and the lowest working power of the whole compact fluorescence lamp are defined.

In an embodiment of the present invention, the dimming module 3300 may further include series resistors R4 and R5. The resistors R4 and R5 are connected in series between the working voltage input node Vcc of the frequency adjustment part 3320 and the output node N1 of the input module 3100, and are also connected in series between the output node N1 of the input module 3100 and the end of the slide resistor VR1, which is connected with the first input node N1 of the input module. The series resistors R4 and R5 are also configured so that voltage output at node N1 falls, so that a lower voltage than the voltage output at node N1 is supplied to the frequency adjustment module 3320 and the voltage adjustment module 3310.

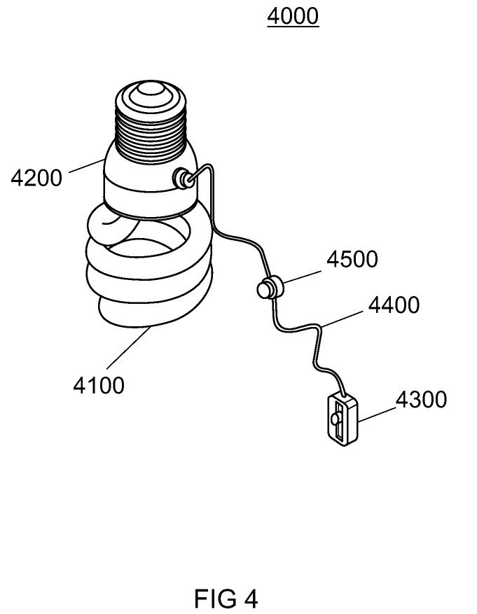

FIG. 4 shows a diagram of an integrated dimmable compact fluorescence lamp according to an embodiment of the present invention. The compact fluorescence lamp, as shown in FIG. 4, includes a circuit for a compact fluorescence lamp according to an embodiment of the present invention. In FIG. 4, the compact fluorescence lamp 4000 includes a spiraliform fluorescence lamp tube 4100 and a lamp tube mounting 4200. In another embodiment, the lamp tube 4100 may also show another suitable form, such as for example a U-shape or an H-shape. Although it is not shown, the circuit may be arranged in the lamp tube mounting 4200.

Furthermore, the compact fluorescence lamp 4000 may also include a slide resistor 4300. In FIG. 4, the slide resistor 4300 is arranged outside the lamp tube mounting 4200 and connected to the lamp tube mounting 4200 and finally to the circuit in the lamp tube mounting 4200 by a conducting wire 4400. The slide resistor 4300 is the slide resistor VR1 in the circuit of the integrated dimmable compact fluorescence lamp according to the embodiment of the present invention.

Furthermore, the conducting wire 4400 may be provided with a fixation apparatus 4500. The fixation apparatus 4500 is configured to fix the conducting wire 4400 at an object like for example a wall, to prevent the conducting wire 4400 from touching the lamp tube 4100.

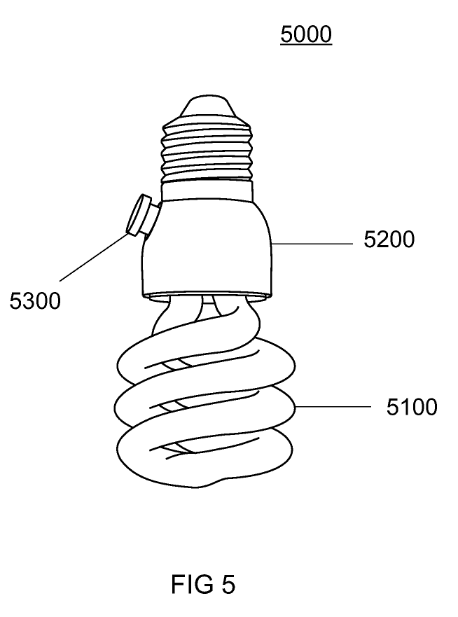

FIG. 5 shows a diagram of an integrated dimmable compact fluorescence lamp according to another embodiment of the present invention. The compact fluorescence lamp 5000, as shown in FIG. 5, also includes a circuit for a compact fluorescence lamp according to an embodiment of the present invention. The integrated dimmable compact fluorescence lamp 5000 in FIG. 5 is different from the one in FIG. 4 in that the slide resistor 5300 in the compact fluorescence lamp 5000 is arranged directly at the outer surface of the lamp tube mounting 5200, whereby the space is reduced. Furthermore, the slide resistor 5300 in the embodiment of FIG. 5 possesses the form of a rotary knob.

It is to be noted that the expressions “comprise”, “include” and any other variations thereof shall cover a non-exclusive inclusion, so that a process, a method, an article or an apparatus, which includes a list of elements, is not necessarily constrained to those elements, but may include other elements, which are not explicitly listed or are inherent in this process, this method, this article or this apparatus. Furthermore, without explicit limitation, the element defined by a sentence “comprises a . . . ” does not exclude an other identical element in the process, the method, in the article or in the apparatus, which comprises the list of the elements.

Although the embodiments of the present invention have been described in connection with the attached drawings, it will be understood, that the above-described embodiments are provided for illustrative purposes only, but do not form the limit of the present invention. A person skilled in the art may perform various modifications and amendments to the embodiments, without departing from the scope of protection of the present invention. Therefore, the scope of protection of the present invention is only defined by the attached claims and their equivalents.

What is claimed is:

1. A circuit for an integrated dimmable compact fluorescence lamp, comprising:
a dimming module configured to adjust the brightness of the compact fluorescence lamp by controlling the frequency of a voltage to be output to a control module, wherein the dimming module comprises:
a control part configured to receive a first electrical signal from an input module and an electrical feedback signal from a lamp tube of the compact fluorescence lamp, generate an electrical reference signal which represents a part of the first electrical signal or the whole electrical signal, adjust the electrical reference signal as reaction to an external operation and output the electrical reference signal and the electrical feedback signal to a frequency adjustment part to control the frequency of a voltage output from the frequency adjustment part; and
the frequency adjustment part configured to receive the first electrical signal from the input module, generate the frequency of the voltage to be output to the control module and adjust the frequency of the voltage as reaction to the electrical reference signal and the electrical feedback signal.

2. The circuit of claim 1,
wherein the first electrical signal from the input module is a direct voltage, the electrical reference signal is a reference direct voltage and the electrical feedback signal from the lamp tube of the compact fluorescence lamp is a feedback alternating voltage.

3. The circuit of claim 2,
wherein the control part comprises:
a slide resistor, wherein the two ends of the slide resistor each are connected to a first output node and a second output node of the input module, and a sliding contact of the slide resistor is connected to a first input terminal of the frequency adjustment part; and
a feedback resistor, wherein the feedback resistor is connected between a reference mass of the circuit and the lamp tube, wherein the end of the feedback resistor connected to the lamp tube is also connected to the first input terminal of the frequency adjustment part, and the feedback resistor is configured to supply the feedback alternating voltage thereto to the first input terminal of the frequency adjustment part, when an alternating current of the lamp tube flows through the feedback resistor.

4. The circuit of claim 3,
wherein the control part further comprises:
a first resistor and a second resistor, which are connected between the first and second node of the input module in series with the slide resistor and each are arranged on both sides of the slide resistor.

5. The circuit of claim 3,
wherein the control part further comprises:
a third resistor and
a first capacitor,
wherein the third resistor and the first capacitor are connected in series between the end of the feedback resistor connected with the lamp tube and the first input terminal of the frequency adjustment part.

6. The circuit of claim 3,
wherein a working voltage input node of the frequency adjustment part is connected to the first output node of the input module and a reference mass voltage input node of the frequency adjustment part is connected to the second output node of the input module.

7. The circuit of claim 3,
wherein the dimming module further comprises:
serial resistors connected between the first output node of the input module and the first working voltage input node of the frequency adjustment part and also between the first output node of the input module and the end of the slide resistor connected with the first output node of the input module.

8. An integrated dimmable compact fluorescence lamp comprising the circuit of claim 1.

9. The integrated dimmable compact fluorescence lamp of claim 8,
wherein the circuit is arranged in a lamp tube mounting of the compact fluorescence lamp.

10. The integrated dimmable compact fluorescence lamp of claim 8,
wherein the compact fluorescence lamp further comprises a slide resistor arranged at an outer surface of the lamp tube mounting, wherein the slide resistor is a part of the dimming module used for adjusting the electrical reference signal as reaction to the external operation.

11. The integrated dimmable compact fluorescence lamp of claim 8,
wherein the compact fluorescence lamp further comprises a slide resistor arranged outside the lamp tube mounting and connected by a conducting wire with the lamp tube mounting, wherein the slide resistor is a part of a dimming module used for adjusting the electrical reference signal as reaction to the external operation.

12. The integrated dimmable compact fluorescence lamp of claim 11,
wherein the conducting wire is provided with a fixation apparatus.
